(19) United States
(12) Patent Application Publication
(10) Pub. No.: US 2023/0343123 A1
(43) Pub. Date: Oct. 26, 2023

(54) USING MODEL UNCERTAINTY FOR CONTEXTUAL DECISION MAKING IN OPTICAL CHARACTER RECOGNITION

(71) Applicant: Automation Hero, Inc., San Francisco, CA (US)

(72) Inventors: Maximilian Michel, Berlin (DE); Andreas Syrén, Berlin (DE)

(21) Appl. No.: 18/123,871

(22) Filed: Mar. 20, 2023

Related U.S. Application Data
(60) Provisional application No. 63/332,991, filed on Apr. 20, 2022.

(51) Int. Cl. G06V 30/22; G06V 30/19; G06V 20/62

(52) U.S. Cl. CPC G06V 30/22; G06V 30/191; G06V 20/62; G06V 30/19007

(57) ABSTRACT

A system recognizes text in an input image. The system provides the input image to one or more optical character recognition (OCR) models to obtain predicted texts. The system determines a set of candidate text predictions by performing text recognition on each transformed image of the set of transformed images. The system generates a regular expression based on the predicted characters of the candidate text predictions and confidence score corresponding to each predicted character. The system matches the regular expression against text values in a database. The system selects one or more text values from the database based on the matching and returns the one or more text values as results of recognition of text of the input image.

### CROSS REFERENCE TO RELATED APPLICATIONS

This application claims the benefit of priority under 35 USC 119(e) to U.S. Provisional Application No. 63/332,991 entitled “USING MODEL UNCERTAINTY FOR CONTEXTUAL DECISION MAKING IN OPTICAL CHARACTER RECOGNITION,” filed on Mar. 23, 2022, which is incorporated herein by reference in its entirety for all purposes.

### BACKGROUND

### Field of Art

The disclosure relates in general to optical character recognition, and in particular to using model uncertainty for contextual decision making in optical character recognition.

### Description of the Related Art

Conventional optical character recognition (OCR) techniques process an image displaying text data to recognize the text data. Accordingly, these techniques convert an image of a document or a label to a digital representation of the text. The input image may include handwritten text. OCR of handwritten text typically has low accuracy since different people have different handwriting and there is large variation in the way people may write the same characters. Artificial intelligence techniques are used for OCR of handwritten text. For example, machine learning based models such as neural networks are used for performing OCR of handwritten text. Machine learning techniques require large amount of training data for training the machine learning model. However, if the machine learning model is provided with input that is different from the type of data presented during training the machine learning model is likely to make inaccurate predictions.

### SUMMARY

A system exposes model uncertainty in a machine processable format to enable contextual decision making for recognizing text in images. The system receives an input image of text displaying characters, for example, handwritten text displaying handwritten characters. The system provides the input image to one or more optical character recognition (OCR) models to obtain predicted texts. An example of an OCR model is a neural network model that classifies an input image. Each predicted text includes predicted characters corresponding to the handwritten characters. Each predicted character is associated with a confidence score. The system generates a regular expression based on the predicted characters. The regular expression includes terms. Each term is determined based on the predicted characters and the confidence score corresponding to a predicted character. The system matches the regular expression against text values in a database. The system selects text values from the database based on the matching and returns the text values as results of recognition of text of the input image.

According to an embodiment, if the system determines that each predicted characters matches a particular character value, the system uses a term of the regular expression that performs exact match on the particular character value. Accordingly, if a predicted character has more than a threshold confidence score, the system uses a term of the regular expression that performs exact match on the predicted character.

According to an embodiment, if each of the one or more predicted characters has a confidence score that is below a threshold value, the system uses a term of the regular expression that performs fuzzy match based on the predicted characters.

According to an embodiment, if the system identifies a plurality of predicted characters corresponding to a handwritten character, the system uses a term of the regular expression that performs fuzzy match based on the plurality of predicted characters. The system may generate a regular expression such that a term of the regular expression uses a boolean “or” expression that performs a match against any one of the plurality of predicted characters.

According to an embodiment, the system receives a context associated with the handwritten text and selects a dataset from the database based on the context and performs the matching of the regular expression against the dataset.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows an overall system environment illustrating a system that performs optical character recognition (OCR) on images, in accordance with one or more embodiments.

FIG. 2 illustrates the overall process of recognizing text from images, in accordance with one or more embodiments.

FIG. 3 shows system architectures of an OCR module, in accordance with one or more embodiments.

FIG. 4 shows a process for recognizing text in an image, in accordance with one or more embodiments.

FIG. 5 shows an example candidate string generated from an input image, according to an embodiment.

FIG. 6 shows another process for recognizing text in an image, in accordance with one or more embodiments.

FIG. 7 shows a block diagram including components of an example machine able to read instructions from a machine-readable medium and execute them in a processor (or controller).

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

A method and system perform optical character recognition (OCR) of text in images. The system provides the input image to an OCR model that predicts the text in the image and assigns a measure of uncertainty to the predicted text. The system uses the measure of uncertainty of the model to perform lookups of text in a set of values, for example, values stored in a database.

Optical character recognition (OCR) is a process that receives images displaying text, for example, scanned images and converts them into text, for example, a sequence of characters represented in a computer processor. This allows a system to convert images of paper-based documents or any surface displaying text, for example packages, cards, containers, billboards, and so on into editable, searchable, digital documents. The resulting documents contains text that can be processed by a computer processor. The process can be used to reduce the amount of physical space required to store documents and can be used to improve workflows involving those documents.

Embodiments include computer-implemented methods comprising the steps described herein. Embodiments include computer readable non-transitory storage media storing instructions that when executed by one or more computer processors cause the one or more computer processors to perform steps of methods disclosed herein. Embodiments include computer-implemented systems comprising one or more computer processors and computer readable non-transitory storage media storing instructions that when executed by the one or more computer processors cause the one or more computer processors to perform of the methods disclosed herein.

### System Environment

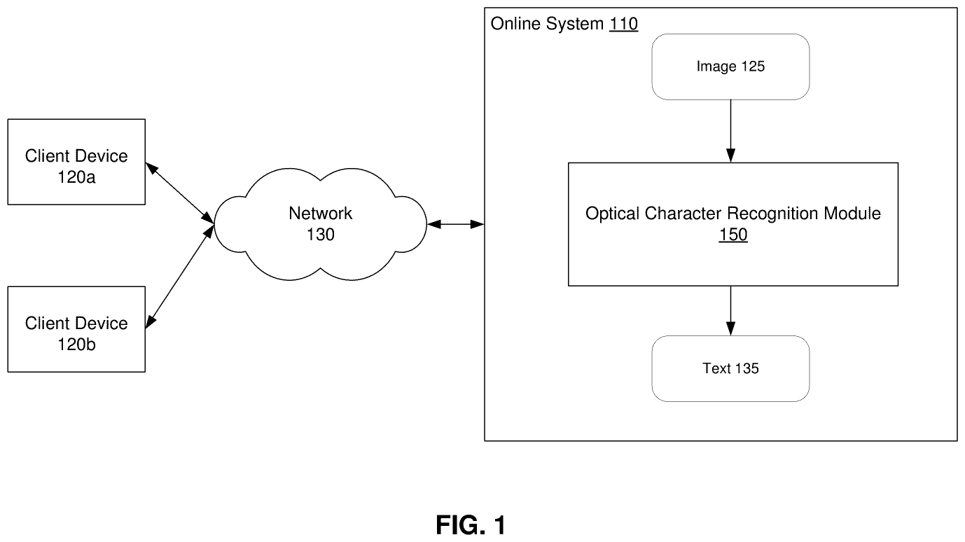

FIG. 1 shows an overall system environment illustrating an online system 110 that performs optical character recognition (OCR) on images received from a client device 120, in accordance with one or more embodiments. The system environment includes an online system 110, one or more client devices 120a, 120b, and a network 130. Other embodiments may use more or less or different systems than those illustrated in FIG. 1. Functions of various modules and systems described herein can be implemented by other modules and/or systems than those described herein.

FIG. 1 and the other figures use like reference numerals to identify like elements. A letter after a reference numeral, such as “120a,” indicates that the text refers specifically to the element having that particular reference numeral. A reference numeral in the text without a following letter, such as “120,” refers to any or all of the elements in the figures bearing that reference numeral (e.g., “120” in the text refers to reference numerals “120a” and/or “120b” in the figures).

A client device 120 is used by users to interact with the online system 110. The client device 120 provides the online system 110 with an image that includes text, for example handwritten text. The image may be captured from handwritten text on paper or other objects. Alternatively, the handwritten text may be generated by applications configured to allow users to use handwriting for specifying text, for example, applications for handwriting tablets. However, the techniques disclosed are applicable to text that may not be handwritten and may be machine generated or text based on various types of font. The text may be captured using images or videos.

In some embodiments, the client device 120 captures the image and/or a video of an object including text with a camera. Examples of objects that may be captured include paper in notebooks, bottles, envelopes, checks, and so on. A user may capture the image of the object using the client device 120, for example, a phone or a tablet equipped with a camera. The camera may be mounted on a vehicle, for example, a car. In some embodiments, the client device 120 is a component of a system that automatically captures the image and/or video of the object. In other embodiments, the client device 120 receives the image of the object from another client device. The client device 120 may receive and/or capture a plurality of images of the object. The client device 120 interacts with the online system 110 using a client application on the client device 120. An example of a client application is a browser application. In an embodiment, the client application interacts with the online system 110 using HTTP requests sent over network 130.

The online system includes an optical character recognition (OCR) module 150 that processes images to recognize text in the input images. The online system 110 receives an image 125 and provides the received image 125 as input to the OCR module. The OCR module processes the input image 125 using the processes disclosed herein to identify text 135 in the image 125. The text 135 generated by the image may be output to a client device 120 via the network 130. Alternatively, the text 135 may be used for certain downstream processing for example, to trigger a workflow. The text 135 may be stored in a data store to allow users to perform text search through a large number of documents.

The online system 110 and the client device 120 communicate over the network 130, which may be, for example, the Internet. In one embodiment, the network 130 uses standard communications technologies and/or protocols. In another embodiment, the network 130 comprises custom and/or dedicated data communications technologies instead of, or in addition to, the ones described above. The techniques disclosed herein can be used with any type of communication technology, so long as the communication technology supports the transmission of data from the client device 120 to the online system 110, and vice versa.

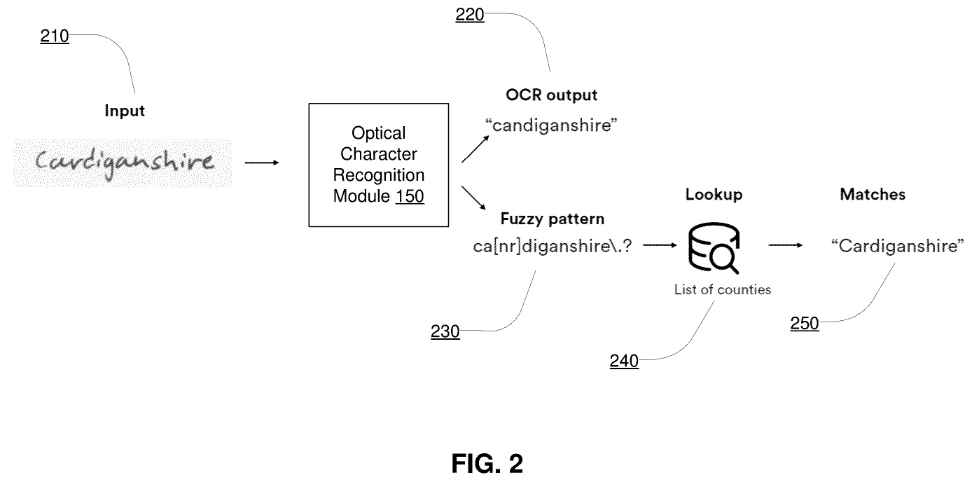

FIG. 2 illustrates the overall process of recognizing text from images, in accordance with one or more embodiments. The steps may be performed by a system, for example, the online system 110 or by any other computing system. The system receives an input image 210 including text, for example, handwritten text. The OCR module 150 processes the input image 210 to predict the text in the image as the OCT output 220. The OCR module 150 further generates a search expression, for example, a regular expression 230 using fuzzy patterns. The online system uses the context of the image to determine the type of data in which to perform the search. For example, the type of data may be determined based on a field of a form that was scanned, such as a city name, a county name, a country name, and so on. The system performs lookup 240 in a data store that stores specific type of data being searched. The system performs lookup 240 in a data store that stores specific type of data being searched. The system obtains a result text string 250 from the data store that matches the search expression 230. The result text string 250 may be returned to a client device or used for further downstream processing.

### System Architecture

FIG. 2 shows system architectures of the OCR module 150 according to an embodiment. The OCR module 150 includes an image transformation module 310, one or more OCR models 320, a search expression builder 330, a lookup module 340, and one or more data stores 350. In some embodiments, the OCR module 150 is integrated into the online system 110 of FIG. 1. In other embodiments, the OCR module 150 is separate from, but communicates with, the online system 110.

The data store 350 stores data of different data types. For example, the data store 350 may include various data structures such as tables or relations that store data of a specific data type. Examples of types of data stored in the data store 350 include city names, country names, county names, names of people, for example, employees of an organization, names of organizations, and so on. The OCR module 150 performs context specific search for the appropriate type of data by determining a context associated with an input image.

The image transformation module 310 performs various transformations of an input image. Each transformation performs processing of the image to obtain a different image that differs in some characteristics from the input image. For example, the transformed image may be resized along one or more dimensions, the transformed image may be stretched in a combination of directions, the brightness of the image may be changed, certain colors in the image may be enhances, the contrast of the image may be changed, and so on.

The transformed images are provided as input to one or more OCR models 320. An OCR model receives an input image to recognize text in the input image. The input image may include text that includes a plurality of input characters. The OCR model 320 may recognize a character corresponding to each input character. In an embodiment, the OCR model 320 outputs a confidence score that measures a degree of uncertainty of the recognized output. The confidence score may be output for each character recognized in the input image. For example, certain characters from the input image may be recognized with high confidence score, whereas some characters may be recognized with low confidence score. In an embodiment, the OCT module 150 provides the same input image to different OCR models, wherein each OCR model may recognize at least a subset of the characters of the output text string differently. For example, an OCR model M1 may recognize a particular input character to be a character c11 with confidence score s11, whereas an OCR model M2 may recognize the same input character to be a character c12 with confidence score s12. Furthermore, the same OCR model is provided with different transformed images obtained from the same input image. Accordingly, the same OCR model may recognize the same input character as different predicted characters for different transformed images. Each predicted character is associated with a confidence score. For example, an input image may be transformed into image I1 and I2. The same input character in the input image is recognized by the OCR model M1 as character c21 with confidence score s21 when processing the transformed image I1 but as character c22 with confidence score s22 when processing the transformed image I2. Accordingly, based on use of multiple OCR models 320 or based on use of multiple transformed images obtained from the same input image, the OCR module 150 may predict one or more characters corresponding to each input character in the input image, each predicted character associated with a confidence score output by the corresponding OCR model used to output the predicted character.

In an embodiment, the system performs a plurality of transformations of the input image and provides each of the transformed images to one of a plurality of OCRT models. Accordingly, if the system applies M transformations and uses N OCR models, the system generates M*N candidate text strings based on the same input image.

According to an embodiment, an OCR model 320 is a machine learning based model. The machine learning based model is trained to predict text in an input image. The machine learning based model is trained using a training dataset that includes a set of images including text (e.g., words, phrases, or sentences). For each image in the set, the training dataset includes the text that is in the image. The machine learning model is trained using the training dataset. The training process adjusts the parameters of the machine learning model using a process such as back propagation that minimizes a measure of a loss value representing a difference between the know text of an image and the text predicted by the model.

According to an embodiment, the machine learning based model is trained using images included in a positive training set and in a negative training set. For a given object, the positive training set may include images with a particular character, whereas the negative training set includes images without the particular character. According to an embodiment, the OCR model 320 extracts feature values from the images in the positive and negative training sets, the features being variables deemed potentially relevant to whether or not the images include a particular character or a particular text string. Features may include colors, edges, and textures within the image and are represented by feature vectors.

According to an embodiment, the OCR model 320 is a supervised machine learning based model. Different machine learning techniques—such as linear support vector machine (linear SVM), boosting for other algorithms (e.g., AdaBoost), neural networks (deep learning neural networks, for example, transformer models), logistic regression, naïve Bayes, memory-based learning, random forests, bagged trees, decision trees, boosted trees, or boosted stumps—may be used in different embodiments. The trained OCR model 320, when applied to the image, extracts one or more feature vectors of the input image and predicts characters in the text of the input image and a confidence score for each predicted character. According to an embodiment, the trained OCR model 320 is a classifier that classifies an image or a portion of an image to a predict a character.

The search expression builder 330 receives the outputs of the OCR models 320 and builds a search expression for looking up in the data store 350. In an embodiment, the search expression builder 330 builds a regular expression based on the value or values of each character in the input text that is predicted by the OCR models 320. The search expression builder 330 uses the confidence scores for each predicted character to build a regular expression. In an embodiment, the regular expression is a fuzzy regular expression that allows regular expression patterns to match text within a set percentage of similarity. Accordingly, the expression built by the search expression builder 330 may perform approximate string matching. The regular expression generated by the search expression builder 330 may include wild cards, Boolean operators, grouping of characters, quantifiers, and so on. The type of operator included in the regular expression depends on the characters predicted by the OCR models 320 and their corresponding confidence scores.

The lookup module 340 receives the search expression, for example, the regular expression built by the search expression builder 330 and performs the search in the appropriate data set within the data store 350. The lookup module 340 identifies search strings that are determined to have the best match with the regular expression. The result text string identified by the lookup module 340 is used as the result of the text recognition of the input image.

### Process of Performing OCR

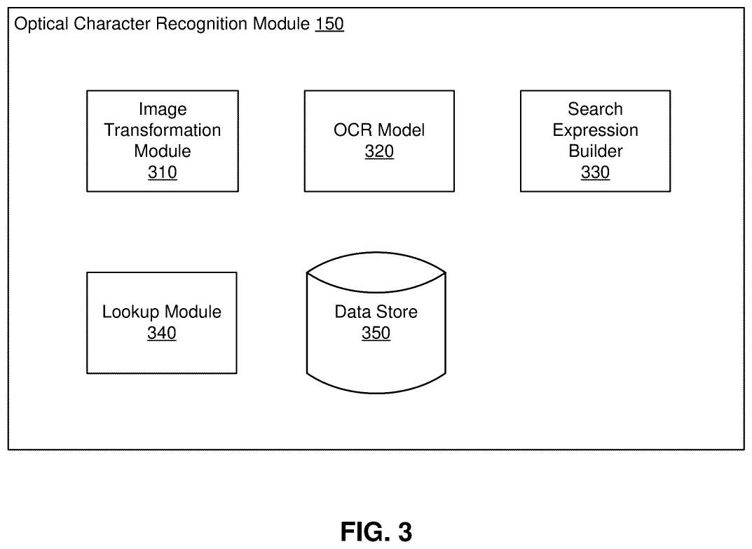

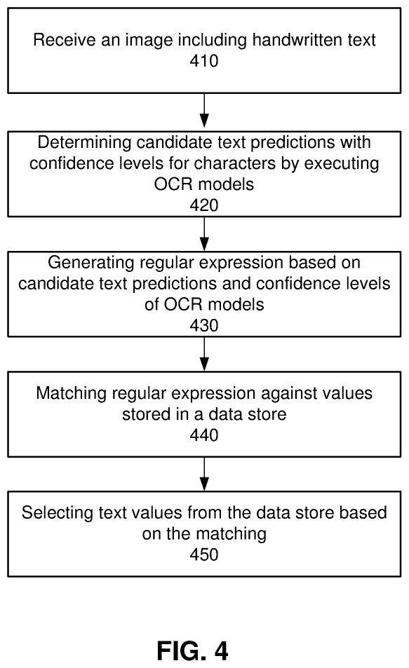

FIG. 4 shows a process for recognizing text in an image, in accordance with one or more embodiments. In various embodiments, the steps of the process may be executed in an order different from that described in FIG. 4. For example, certain steps may be executed in parallel. The steps are described as being executed by a system, for example, the online system 110 and may be executed by modules, for example, the OCR module 150 or other modules illustrated in FIG. 3.

The system receives 410 an input image comprising text, for example, handwritten text. The text of the input image is referred to as the input text and comprises one or more input characters. For example, the input characters may be handwritten characters. The input characters refer to portions of the input image that are likely to represent characters of the input text. The input characters may not clearly map to a known character of an alphabet. For example, the input characters may be written in a handwriting that may not be fully legible and at least some of the characters may map to multiple target characters. The system performs the following steps to recognize the input text and map the input characters to characters of an alphabet.

The system determines 420 a set of candidate text predictions by performing text recognition on the input image. In an embodiment, the system transforms the input image to multiple transformed images, each obtained by performing one or more transformations. Examples of transformations are disclosed herein. The system executes an OCR model to recognize text in each transformed image. In another embodiment, the system provides each transformed image to multiple OCR models to obtain a different candidate text prediction. Each candidate text prediction represents a sequence of characters recognized in the input image. Each character in the sequence of characters is associated with a confidence score indicating a degree of uncertainty with which the OCR model recognized the character.

The system generates 430 a search expression, for example, a regular expression based on the candidate text predictions. The regular expression is determined based on the characters of the candidate text predictions and their corresponding confidence scores.

The system matches 440 the generated regular expression against values stored in a data store. In an embodiment, the system selects a dataset within the data store based on a context associated with the image. The system may identify one or more top matching text values based on the regular expression. The system selects 450 a text value from the database based on the matching and returns as the result of the text prediction based on the image.

In an embodiment, the input text string comprises of a sequence of input characters. For example, the input text string may be a handwritten text string that comprises a sequence of handwritten characters. Each candidate text string represents a sequence of output characters that correspond to the sequence of input characters. For example, the candidate text string may include one output character corresponding to each input character. For each input character, the system identifies pairs of output characters and confidence scores obtained from the candidate text strings. Since there are a plurality of candidate text strings, the system determines a set of pairs of output characters and confidence scores, each pair obtained from a candidate text string. The system determines terms of the regular expression based on the set of pairs of output characters and confidence scores corresponding to each input character.

In an embodiment, the system generates a regular expression comprising a sequence of terms, each term corresponding to an input character. A text string matches the regular expression if each of the terms of the regular expression match the corresponding characters of the text string. A term may be a particular character such that a text string matching the regular expression has that particular character at the location corresponding to the term. A term may be a boolean OR expression comprising a set of characters, such that a text string matching the regular expression would have a character from the set of characters at the location corresponding to the term. A term may be a wild card expression such that a text string matching the regular expression can have any character at the location corresponding to the term.

In an embodiment, if all output characters in the set of pairs corresponding to the input character match (i.e., they are all identical), the system uses that output character as a term in the regular expression. In an embodiment, if more than a threshold percentage of pairs corresponding to a location in the input text indicate that the output at that location is a particular character, the system uses that particular character as a term in the regular expression at that location. For example, if more than 80% of candidate text strings indicate that the character at a particular location in the output strings is character C (e.g., ‘a’), the system assumes that the input character at that location must match character C and accordingly uses a term matching character C at that location in the regular expression. Alternatively, if the set of pairs includes a character that has a confidence score that is greater than a threshold value, the system uses that output character as a term in the regular expression. Accordingly, the system generates a regular expression that performs an exact match with the character if the corresponding confidence score is greater than the threshold value. This is so because the likelihood of that input character matching the output character is determined to be high. In an embodiment, the system ignores pairs from the set of pairs that have confidence level below a threshold value.

In an embodiment, if the set of pairs includes a subset of pairs such that each pair in the subset has a character that has a confidence score that is greater than a threshold value, the system uses a boolean OR expression that includes the subset of characters as a term in the regular expression. Accordingly, a text string matching the regular expression would have a character form the subset of characters at the location corresponding to the term.

In an embodiment, if the none of the pairs in the set of pairs corresponding to an input character at a location has a confidence score that is greater than a particular threshold value, the system includes a term that is a wild card character at that location. Alternatively, if all the pairs in the set of pairs corresponding to an input character at a location have a confidence score that is below a threshold value, the system includes a term that is a wild card character at that location. The wild card character represents a term in the regular expression that can match any character. The system uses a wildcard character because the system could not find any character that corresponds to the input character with high confidence.

In an embodiment, the system identifies common subsequences of characters that exist across more than a threshold number of candidate text strings. These common subsequences are included as subsequences of characters in the regular expression. The system uses various fuzzy terms at remaining positions of the input text where the candidate text strings do not predict a consistent output character.

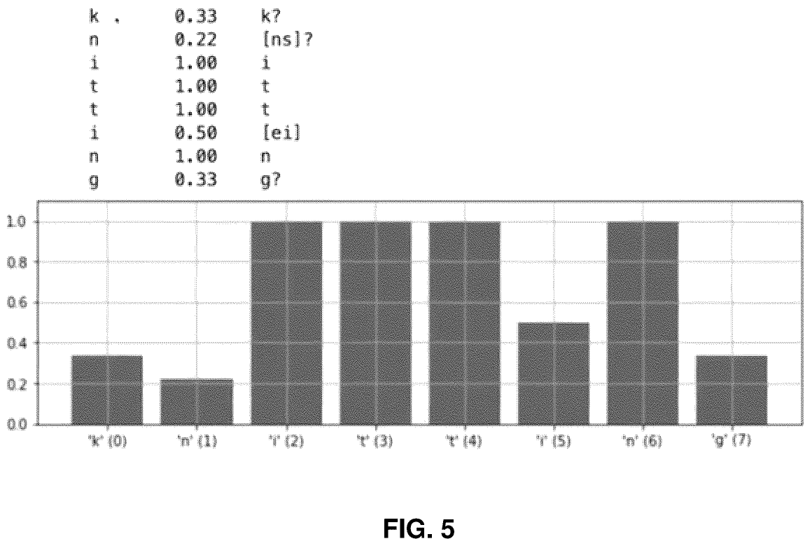

FIG. 5 shows an example candidate text string generated from an input image, according to an embodiment. The system predicts character ‘k’ at position 0 with confidence score 0.33, characters ‘n’ or ‘s’ at position 2 each with confidence score 0.22, characters T, ‘t’, and T at positions 2, 3, and 4 respectively each with confidence score 1.00, characters ‘e’ or T at position 5 each with confidence scores 0.5, character ‘n’ at position 6 with confidence score 1.00, and character ‘g’ at position 7 with confidence scores 0.33. Accordingly, the regular expression includes terms with characters i′, ‘t’, T, and ‘n’ at positions 2, 3, 4, and 6 respectively since the confidence score is high (above a threshold value). For position 0, since the confidence score is below a threshold, the regular expression includes a term ‘k?’ that indicates that at this position the character ‘k’ may exist or not exist (i.e., 0 or 1 occurrence of character ‘k’). For position 1, since there are two possible predicted characters, both with confidence scores below a threshold, the regular expression includes a term ‘ns?’ that indicates that at this position the character ‘n’ may exist or character ‘s’ may exist or none of these two characters may exist. For position 5, since there are two possible predicted characters ‘e’ and ‘I’, both with confidence scores above a threshold, the regular expression includes a term ‘ei’ that indicates that at this position the character ‘n’ may exist or character ‘s’ may (but one of these two characters must exist). Accordingly, the final regular expression generated is “k?[ns]?itt[ei]ng?”.

In an embodiment, the various threshold values used for generating the regular expressions are configurable. For example, an expert user can configure the different threshold values. The system may use a configuration file in which the threshold values are used. In another embodiment, the system adaptively changes the threshold values to improve the accuracy of the results. Accordingly, the system trains the parameter values representing the thresholds used for generating the regular expressions. For example, the system adjusts one or more threshold values and matches against a data set to monitor the number of result strings that match a regular expression. If the number of result strings from the data set that match the regular expression is above a threshold value, the system adjusts the thresholds used for generating the regular expressions so as to reduce the number of matching result strings. For example, if too many result strings match a regular expression based on a threshold value, the system may reduce the threshold value used to generate the regular expression and match the new regular expression against the data set to check if the number of matching result strings is smaller. If the number of matching result strings is reduced as a result of adjusted threshold values used to generate the regular expression, the system subsequently starts using the adjusted threshold values for generating regular expressions.

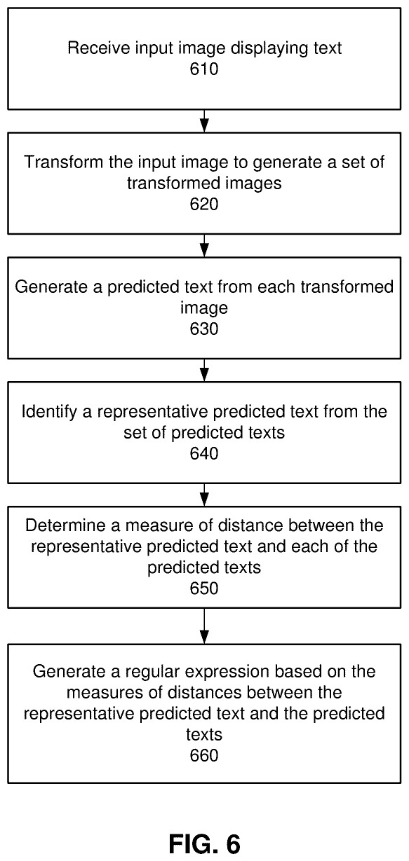

FIG. 6 shows another process for recognizing text in an image, in accordance with one or more embodiments. The system determines a set of predicted texts based on the input image. The term predicted text is also referred to as a candidate text prediction. The system analyzes the set of predicted texts to determine the differences between the various predicted texts. The system determines the portions of the predicted texts that agree with each other and portions of the predicted text that disagree with each other. Accordingly, the system determines portions of the predicted texts where the predictions are accurate and portions of the predicted texts where the predictions are inaccurate. The system determines a regular expression based on the differences and similarities between the predicted texts of the set of predicted texts. Accordingly, the regular expression includes terms associated with various portions of the predicted text that are determined based on the degree of accuracy of the predictions of that portion of the predicted text. For example, if system determines that a portion t1 of the predicted text is predicted with high degree of confidence (or accuracy), the system uses a regular expression term based on strict match, whereas if system determines that a portion t2 of the predicted text is predicted with low degree of confidence (or below a threshold degree of accuracy), the system uses a regular expression term based on fuzzy match. The system may control the degree of fuzziness of the match of a term of the regular expression corresponding to a portion of the predicted text based on the degree of accuracy of prediction of that portion of the predicted text. For example, the system may allow a particular term to match more characters or sets of characters (allow higher fuzziness) if the term corresponds to a portion of the predicted texts that has low accuracy of prediction and similarly, the system may allow a particular term to match fewer characters or sets of characters (perform strict match) if the term corresponds to a portion of the predicted texts that has high accuracy of prediction.

In various embodiments, the steps of the process may be executed in an order different from that described in FIG. 4. For example, certain steps may be executed in parallel. The steps are described as being executed by a system, for example, the online system 110 and may be executed by modules, for example, the OCR module 150 or other modules illustrated in FIG. 3.

The system receives 610 an input image. The input image displays text, for example, handwritten text or any other form of text. The system may preprocess the image to extract a bounding box that includes the text. The system may determine a context associated with the bounding box, for example, store information describing the portion of t the image that was extracted. For example, the image may represent a form and the input text may represent a handwritten text answering a specific question such as provide county, provide city name, and so on. Accordingly, the system may track the type of information represented by the text within the bounding box.

The system transforms 620 the input image to generate a set of transformed images. For example, the system may augment the image by performing one or more transformations (or augmentations) such as stretching the image, rotating the image, changing contrast, inverting the image, adding random noise (e.g., static in the image), adding spurious lines (e.g., underlines) or curves, and so on as well as performing combinations of the transformations such as performing both rotation and stretching. Accordingly, the system may generate M transformed images.

The system generates 630 one or more predicted texts from each transformed image from the set of transformed image. If each transformed image is provided as input to a plurality of OCR models (e.g., K OCR models), the system generates N=M*K predicted texts from the input image. Different OCR models may use different techniques for performing OCR or may be trained using different types of training data set and may make different predictions for the same input image.

The system identifies 640 a representative predicted text from the set of predicted texts. In an embodiment, the system identifies the representative predicted text as the central candidate among the N predicted texts in terms of edit distance, for example, levenshtein edit distance. In an embodiment, the representative predicted text is a medoid of the set of predicted texts. The medoid of the set of predicted texts is a representative predicted text from the set of predicted whose sum of dissimilarities to all the predicted texts in the set of predicted texts is minimal. For example, the representative predicted text is the predicted text that has the minimum edit distance from each of the remaining predicted text of the set of predicted texts. According to an embodiment, the system determines pairs of predicted texts and determines edit distances between the pairs of predicted texts. The system determines an aggregate edit distance for each predicted text by adding the edit distances from that predicted text and each of the remaining predicted texts. The system selects the predicted text that has the minimum aggregate edit distance from the remaining predicted texts as the representative predicted text. For example, if the set of predicted texts is represented as the set Ŷ_{c} [symbol] ŷ_{c,i}, the medoid candidate prediction ŷ_{c,m} is the predicted text such that m is obtained using the following equation.

$$m = {ArgMin}_{j} {\sum }_{i = 0}^{N} 〈 {\hat{y}}_{c , i} , {\hat{y}}_{c , j} 〉 \qquad ( 1 )$$

In this equation, the operation <•, •> is the Levenshtein edit distance but may represent another measure of distance, for example, edit distance based on a different criteria. According to equation (1), the medoid predicted text ŷ_{c,m} is determined to be the predicted text from the set of predicted texts such that sum of edit distances of ŷ_{c,m} to all other predicted texts is minimal.

The representative predicted text may be a member of the set of predicted texts but is not required to be. For example, the representative text may be a centroid of the set of predicted texts determined using an aggregate operation, for example, by determining a mean data point from a set of data points.

The system determines 650 a measure of distance between the representative predicted text and each of the predicted texts. In an embodiment system performs traversals from the medoid predicted text to all the remaining predicted texts based on various edit operations. For example, the system performs traversals in terms of three levenshtein edit distance operations: edit, delete and insert. The system records the set of edit operations performed on each character of the medoid predicted text to reach a target predicted text. The system may record insertions as dummy characters indexed by the insertion location.

The system generates 660 a regular expression based on the measures of distances between the representative predicted text and the predicted texts. The system uses the recorded edits between the medoid predicted text and the remaining predicted texts to construct a regular expression. The system aggregates the sets of edit operations performed for each character of the medoid predicted text to reach the target predicted texts of the set of predicted texts. The system assigns each character in the medoid predicted text and a target predicted text with a confidence score. In an embodiment, the confidence score is a value between 0 and 1 determined as the expression (times_not_edited+times_inserted)/(number_of_alternative_edits+times_deleted)*number_of_candidates. In this expression, the term times_not_edited represents the number of candidates where the character is not changed, the term times_inserted represents the number of candidates where this character was inserted, the term number_of_alternative_edits represents the number of alternative characters used in the other candidates, the term times_deleted represents the number of candidates where this character was deleted, and the term number_of_candidates represents the total number of candidates created by the OCR engine. In an embodiment, the confidence score for a character of the medoid predicted text depends on the number of times the character had to be edited (e.g., deleted or modified) to reach the remaining predicted texts of the set of predicted texts. Accordingly, the confidence score for a character of the medoid predicted text is directly proportionate to the number of times a character remains unedited if the medoid predicted text was modified to reach each of the set of predicted texts. The confidence score for a character of the medoid predicted text is inversely proportionate to the number of alternative edits of the character if the medoid predicted text was modified to reach each of the set of predicted texts. The confidence score for a character of the medoid predicted text is inversely proportionate to the number of times the character of the medoid predicted text was deleted to reach each of the set of predicted texts. The system uses a wild card term in the regular expression for each character with a confidence below a certain threshold (e.g., ‘f*zz*’). The system uses a term of regular expression utilizing character alternatives (e.g f[uo]zz[yx]) to represent traced edits.

There may be multiple ways to edit the medoid predicted text to a target predicted text. According to an embodiment, the system obtains the optimal edit distance by determining the minimum number of edit operations required to go from the medoid predicted text to a target predicted text.

In an embodiment, the system uses a set of threshold values to generate a regular expression based on the confidence scores. The system may use a threshold T1 such that if a character of medoid predicted text has confidence below T1, that character is replaced by a wild card character in the regular expression that can match any character. The system may use a threshold T2 such that if a character of medoid predicted text has confidence above T2, the regular expression uses that particular character in the regular expression. The system may use a threshold T3 such that if a character of medoid predicted text has confidence above T3 and is replaced by a set of characters to reach the predicted characters, the regular expression uses a term that allows alternative texts based on the set of characters (e.g., [cde]) in the regular expression. The system may use a threshold T4 such that if a character of medoid predicted text may be replaced by a set of characters S such that the cardinality of S is greater than T4 (indicating a high degree of uncertainty), the regular expression uses a wildcard term in the regular expression.

In some embodiments, different sets of threshold values are determined for different types of data sets. The threshold values may depend on the characteristics of the data sets for example, based on the distribution of the values within the data set. For example, the set of county names may have one set of threshold values whereas the set of last names of users may have a different set of threshold values and the set of street names may have a different set of threshold values.

The disclosed techniques provide a computationally efficient mechanism for generating a regular expression based on the set of predicted texts. For example, the regular expression may be generated by exploring all possible pairs of predicted texts. That approach requires managing a large number of combinations of strings and is expected to be highly computationally intensive. The use of a representative predicted text and comparing the representative predicted text simplifies the complexity of determination of the regular expression.

### Computing Machine Architecture

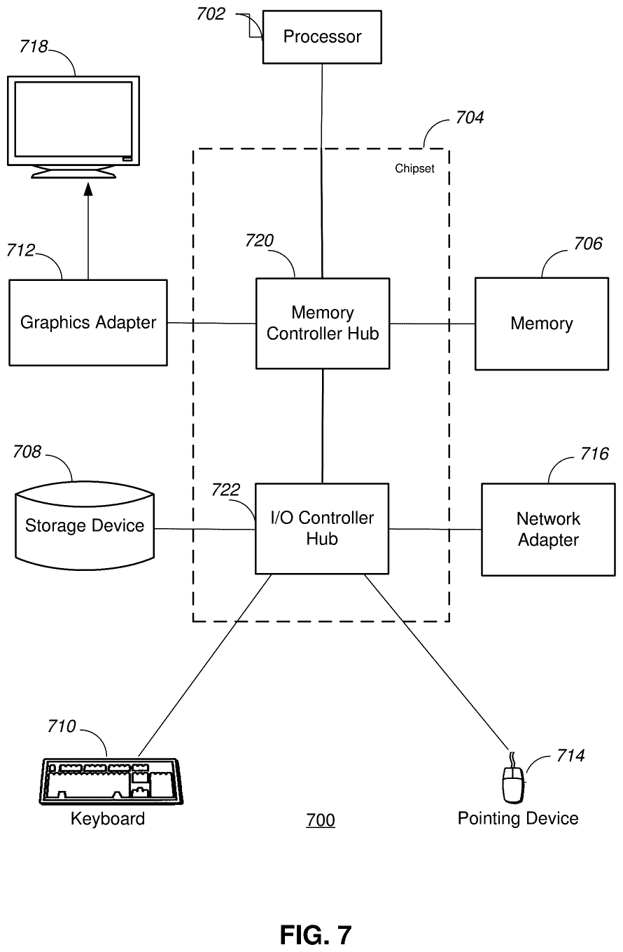

FIG. 7 illustrates a block diagram including components of an example machine able to read instructions from a machine-readable medium and execute them in a processor (or controller). Specifically, FIG. 7 shows a diagrammatic representation of a machine in the example form of a computer system 700 within which program code (e.g., software) for causing the machine to perform any one or more of the methodologies discussed herein may be executed. The program code may be comprised of instructions executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device 712 (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the Figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative structural and functional designs for a system and a process for improving the accuracy of optical character recognition through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for performing character recognition in images, the computer-implemented method comprising:
receiving an input image of handwritten text comprising one or more handwritten characters;
providing the input image to one or more optical character recognition (OCR) models to obtain predicted text comprising one or more predicted characters, wherein a predicted character corresponds to a handwritten character and is associated with a confidence score;
generating a regular expression based on the one or more predicted characters, wherein the regular expression includes terms, each term determined based on the one or more predicted characters corresponding to a handwritten character and the confidence score corresponding to each of the one or more predicted characters;
matching the regular expression against text values in a database;
selecting one or more text values from the database based on the matching; and
returning the one or more text values as results of recognition of text of the input image.

2. The computer-implemented method of claim 1, further comprising:
responsive to determining that each of the one or more predicted characters matches a particular character value, using a term of the regular expression that performs exact match on the particular character value.

3. The computer-implemented method of claim 2, further comprising:
responsive to a predicted character having more than a threshold confidence score, using a term of the regular expression that performs exact match on the predicted character.

4. The computer-implemented method of claim 3, further comprising:
responsive to each of the one or more predicted characters having a confidence score that is below a threshold value, using a term of the regular expression that performs fuzzy match based on the one or more predicted characters.

5. The computer-implemented method of claim 3, further comprising:
responsive to identifying a plurality of predicted characters corresponding to a handwritten character, using a term of the regular expression that performs fuzzy match based on the plurality of predicted characters.

6. The computer-implemented method of claim 5, further comprising:
wherein the term of the regular expression uses a boolean or expression that performs a match against any one of the plurality of predicted characters.

7. The computer-implemented method of claim 1, further comprising:
receiving a context associated with the handwritten text; and
selecting a dataset from the database based on the context, wherein the matching of the regular expression is performed against the dataset.

8. The computer-implemented method of claim 1, wherein at least one of the OCR model is a neural network model.

9. A computer readable non-transitory storage medium storing instructions that when executed by one or more computer processors cause the one or more computer processors to perform steps comprising:
receiving an input image of handwritten text comprising one or more handwritten characters;
providing the input image to one or more optical character recognition (OCR) models to obtain predicted text comprising one or more predicted characters, wherein a predicted character corresponds to a handwritten character and is associated with a confidence score;
generating a regular expression based on the one or more predicted characters, wherein the regular expression includes terms, each term determined based on the one or more predicted characters corresponding to a handwritten character and the confidence score corresponding to each of the one or more predicted characters;
matching the regular expression against text values in a database;
selecting one or more text values from the database based on the matching; and
returning the one or more text values as results of recognition of text of the input image.

10. The computer readable non-transitory storage medium of claim 9, wherein the instructions further cause the one or more computer processors to perform steps comprising:
responsive to determining that each of the one or more predicted characters matches a particular character value, using a term of the regular expression that performs exact match on the particular character value.

11. The computer readable non-transitory storage medium of claim 9, wherein the instructions further cause the one or more computer processors to perform steps comprising:
responsive to a predicted character having more than a threshold confidence score, using a term of the regular expression that performs exact match on the predicted character.

12. The computer readable non-transitory storage medium of claim 9, wherein the instructions further cause the one or more computer processors to perform steps comprising:
responsive to each of the one or more predicted characters having a confidence score that is below a threshold value, using a term of the regular expression that performs fuzzy match based on the one or more predicted characters.

13. The computer readable non-transitory storage medium of claim 9, wherein the instructions further cause the one or more computer processors to perform steps comprising:
responsive to identifying a plurality of predicted characters corresponding to a handwritten character, using a term of the regular expression that performs fuzzy match based on the plurality of predicted characters.

14. The computer readable non-transitory storage medium of claim 13, wherein the instructions further cause the one or more computer processors to perform steps comprising:
wherein the term of the regular expression uses a boolean or expression that performs a match against any one or the plurality of predicted characters.

15. The computer readable non-transitory storage medium of claim 9, wherein the instructions further cause the one or more computer processors to perform steps comprising:
receiving a context associated with the handwritten text; and
selecting a dataset from the database based on the context, wherein the matching of the regular expression is performed against the dataset.

16. A computer-implemented system comprising:
one or more computer processors; and
a computer readable non-transitory storage medium storing instructions thereon, the instructions when executed by the one or more computer processors cause the one or more computer processors to perform steps comprising:
receiving an input image of handwritten text comprising one or more handwritten characters;
providing the input image to one or more optical character recognition (OCR) models to obtain predicted text comprising one or more predicted characters, wherein a predicted character corresponds to a handwritten character and is associated with a confidence score;
generating a regular expression based on the one or more predicted characters, wherein the regular expression includes terms, each term determined based on the one or more predicted characters corresponding to a handwritten character and the confidence score corresponding to each of the one or more predicted characters;
matching the regular expression against text values in a database;
selecting one or more text values from the database based on the matching; and
returning the one or more text values as results of recognition of text of the input image.

17. The computer-implemented system of claim 16, wherein the instructions further cause the one or more computer processors to perform steps comprising:
responsive to determining that each of the one or more predicted characters matches a particular character value, using a term of the regular expression that performs exact match on the particular character value.

18. The computer-implemented system of claim 16, wherein the instructions further cause the one or more computer processors to perform steps comprising:
responsive to a predicted character having more than a threshold confidence score, using a term of the regular expression that performs exact match on the predicted character.

19. The computer-implemented system of claim 16, wherein the instructions further cause the one or more computer processors to perform steps comprising:
responsive to each of the one or more predicted characters having a confidence score that is below a threshold value, using a term of the regular expression that performs fuzzy match based on the one or more predicted characters.

20. The computer-implemented system of claim 16, wherein the instructions further cause the one or more computer processors to perform steps comprising:
responsive to identifying a plurality of predicted characters corresponding to a handwritten character, using a term of the regular expression that performs fuzzy match based on the plurality of predicted characters.
